(19) United States
(12) Patent Application Publication
(10) Pub. No.: US 2010/0117974 A1
(43) Pub. Date: May 13, 2010

(54) TRANSPARENT MULTI-TACTILE SENSOR

(76) Inventors: Pascal Joguet, Sadirac (FR); Julien Olivier, Bordeaux (FR)

Correspondence Address: HARNESS, DICKEY & PIERCE, P.L.C., P.O. BOX 828, BLOOMFIELD HILLS, MI, 48303, US

(21) Appl. No.: 12/594,563

(22) PCT Filed: Apr. 3, 2008
(86) PCT No.: PCT/FR08/00463

§ 371 Date: Oct. 2, 2009

(30) Foreign Application Priority Data
Apr. 5, 2007 (FR) 0754292

(51) Int. Cl. G06F 3/041

(52) U.S. Cl. 345/173

(57) ABSTRACT

The disclosure relates to a transparent multi-tactile sensor including a transparent semi-conducting active layer provided between two transparent conducting layers arranged as an array of cells formed by the intersection of rows and columns, characterised in that it comprises a control circuit successively supplying each semi-conducting portion corresponding to a cell, said control circuit including a means for analyzing the variation in the electrical characteristics due to the deformation of one or more sensor areas, each area including one or more cells, the semi-conducting characteristic of said intermediate layer making said cells independent from the measuring circuit.

### CROSS-REFERENCE TO RELATED APPLICATIONS

This application is a National Phase Entry of International Application No. PCT/FR2008/000463, filed on Apr. 3, 2008, which claims priority to French Patent Application No. 0754292, filed on Apr. 5, 2007, both of which are incorporated by reference herein.

### BACKGROUND AND SUMMARY

The present invention relates to the field of transparent multipoint tactile sensors.

The prior art already knows transparent multipoint tactile sensors. These are, for instance, resistive matrix sensors coupled to a control circuit. Such a sensor is the object of patent no. EP1719047, for example, relating to a virtual object controller through a multi-contact touch screen. Such prior art patent relates to a man-machine interface enabling, for instance, the control of music software through a touch screen with virtual graphical objects handling. It relates to a method for controlling a computerized equipment using a device including a bi-dimensional multi-contact sensor for the acquisition of tactile information, as well as calculation means generating control signals as a function of said tactile information, characterized in that it includes a step of generating graphical objects on a screen positioned under a transparent tactile sensor, with each of the graphical objects being associated with at least a specific processing procedure, with the sensor delivering, upon each acquisition phase, a plurality of tactile information, each of said tactile information being the subject of a specific treatment determined by the localization thereof with respect to the position of one of said graphical objects.

The application for the American patent US20030000721129 relating to an integrated flat OLED touch screen. The touch screen is provided with electrical contacts used for receiving touch screen signals and conducting interconnection holes located through the substate and electrically connected to the electrical contacts. The screen also includes a flat OLED screen having a display substrate provided with electrical contacts used for receiving display signals and a zone exposed on the display substrate so as to produce an electrical connection to the electrical contacts of the display screen and the touch screen. Said substrate of the touch screen composes the coating or the substrate of the flat OLED screen, the conducting interconnection holes are electrically connected to the conductors and to the electrical contacts located on the display substrate, and the substrate of the flat OLED screen protrudes beyond the coating, so as to produce an electrical connection with the electrical contacts of the touch and display screen.

The disadvantage of the prior art sensors is that the arrangement in a passive matrix induces difficulties for detecting several contact points positioned in orthogonal configurations. The control circuit must then compensate these problems as best as possible using redundant measurements and an appropriate digital processing algorithm. This results in a complex control circuit as well as uncertain measures of the contact points.

The solution provided by the present invention consists in implementing a transparent multipoint tactile sensor free of such measuring defects. The present invention aims at remedying such disadvantage using an architecture of transparent multipoint tactile sensors with cells totally independent of one another. However, the screen according to the present invention does not us an active matrix of the TFT (Thin Film Transistor) type which would induce higher manufacturing costs. In addition, the control circuit is more easily implemented than a passive matrix and the manufacturing costs are thus advantageously reduced. Similarly, the industrialization costs of this type of sensor are also reduced.

In its broadest sense, the invention relates to a transparent multi-tactile sensor comprising a transparent semi-conducting active layer located between two transparent conducting layers arranged in a matrix of cells formed by the intersection of rows and columns, characterized in that it includes a control circuit successively supplying each semi-conducting portion corresponding to a cell, said control circuit including means for analyzing the variation in the electrical characteristics caused by the deformation of one or several zones of the sensor, with each zone including one or several cells, the semi-conducting characteristic of said intermediate layer making it possible to make the cells independent of the measuring circuit.

Advantageously, the semi-conducting layer is made of an organic or polymeric material delivered in thin layer. According to an alternative solution, the semi-conducting layer is electrically insulated from one of the adjacent layers using a spacer-held gap, such insulation being locally broken by the deformation of the activated tactile zone. According to another alternative solution, the semi-conducting layer is electrically insulated from one of the adjacent layers using a transparent conducting material, the electrical characteristics of which are locally modified by the deformation of the activated tactile zone. According to another alternative solution, the electrical characteristics of the semi-conducting layer are locally modified by the deformation of the activated tactile zone.

Advantageously, the variation in the electrical characteristics of the activated tactile zone depends on the pressure exerted on said tactile zone. According to a particular embodiment, the semi-conducting layer locally emits light when it is submitted to the electrical activation of a cell, all the local light emissions assimilating it to a display device. According to another alternative solution, the control circuit supplies two scanning frequencies, one for displaying, the other one for reading the position of at least one activated tactile zone.

### BRIEF DESCRIPTION OF DRAWINGS

The invention will be better understood while reading the following description and referring to the appended drawings corresponding to a non limitative embodiment, where:

FIG. 1 shows a cross-sectional view of an exemplary embodiment of the sensor; and

FIG. 2 shows a schematic front view of such a sensor.

### DETAILED DESCRIPTION

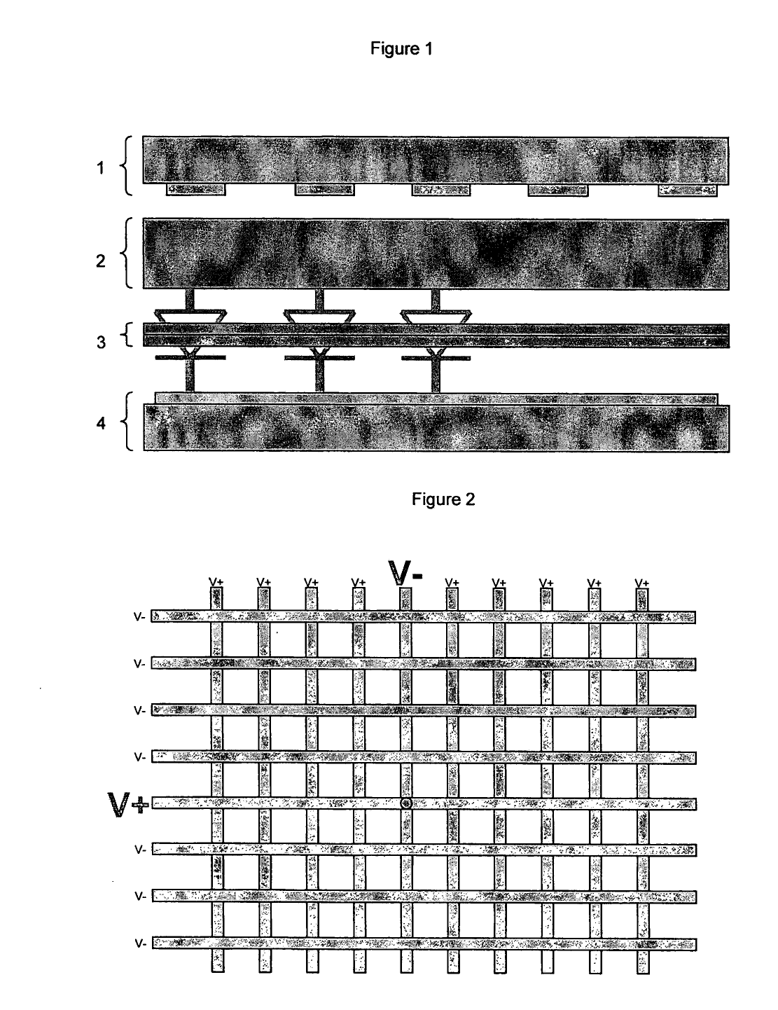

The sensor shown as a cross-section in FIG. 1 includes:
a matrix of M×N cells corresponding to the intersection of X columns×Y rows,
a layer 1 composed of a series of X transparent conducting columns,
a layer 2 composed of a material, the electrical characteristics of which vary (voltage, impedance) as a function of the vertically applied pressure (for instance with a finger or a stylus), or a layer 2 electrically separating the layers 1 and 3 by using for example spacers like in the construction of a conventional resistive tactile slab,
a thin layer 3 composed of a semi-conducting material equivalent to an assembly of vertical diodes,
a layer 4 composed of a series of Y transparent conducting rows such as layer 1.

Layers 1 and 4 can be composed of polyester or glass made conducting with ITO or a thin layer of carbon (nano-tubes). The layer 2 can be composed of transparent piezoelectric materials such as PVDF or a pressure-sensitive conducting material like a polymer filled with conducting particles. In the case where the layer 2 is composed of spacers, the pressure information cannot be measured. The occurrence of a contact or the absence of contact is then simply measured. FIG. 2 shows a front face of the sensor and of the control and measuring circuit.

The principle is as follows:
—Two polarization potentials V+ and V− are defined so that:
* If V+ is applied to a column “x” of the layer 1 and V− to a row “y” of the layer D, the equivalent diode positioned at the intersection P (x, Y) is conducting.
* In all the other polarization combinations (V+ with V+, V− with V+, V+ with V−), the diode is locked.

A measurement is carried out on each cell by simultaneously polarizing the whole of the XY matrix, so as to determine the electrical characteristics thereof relative to the layer 2 and thus the pressure locally exerted on this cell. For measure a cell P(x, Y) all the rows and columns are simultaneously polarized so as to keep the only diode positioned on the cell P conducting and so as to lock all the other diodes located on the other cells.

As this method uses a diode-based active system, it makes it possible to measure each cell separately without being submitted to the electrical interactions connected to a passive matrix: the potentials are not transmitted from one row to the other or orthogonally from one column to the other, using the electrical effect locking the layer of the diode C.

1. A transparent multi-tactile sensor comprising a transparent semi-conducting active layer located between two transparent conducting layers arranged in a matrix of cells formed by the intersection of rows and columns, a control circuit successively supplying each semi-conducting portion corresponding to a cell said control circuit including an analyzer operably analyzing the variation in the electrical characteristics caused by the deformation of one or several zones of the sensor, with each zone including one or several cells, the semi-conducting characteristic of said intermediate layer making it possible to make the cells independent of the measuring circuit.

2. A transparent multi-tactile sensor according to claim 1, wherein the semi-conducting layer is made of an organic or polymeric material delivered in a thin layer.

3. a transparent multi-tactile sensor according to claim 2, wherein the semi-conducting layer is electrically insulated from one of the adjacent layers using a spacer-held gap, such insulation being locally broken by the deformation of the activated tactile zone.

4. A transparent multi-tactile sensor according to claim 3, wherein the semi-conducting layer is electrically insulated from one of the adjacent layers using a transparent conducting material, the electrical characteristics of which are locally modified by the deformation of the activated tactile zone.

5. A transparent multi-tactile sensor according to claim 4, wherein the electrical characteristics of the semi-conducting layer are locally modified by the deformation of the activated tactile zone.

6. A transparent multi-tactile sensor according to claim 1, wherein the variation in the electrical characteristics of the activated tactile zone depends on the pressure exerted on said tactile zone.

7. A transparent multi-tactile sensor according to claim 6, wherein the semi-conducting layer locally emits light when it is submitted to the electrical activation of a cell, all the local light emissions assimilating it to a display device.

8. A transparent multi-tactile sensor according to claim 1, wherein the control circuit supplies two scanning frequencies, one for displaying, the other one for reading the position of at least one activated tactile zone.
